(19) United States
(12) Patent Application Publication
(10) Pub. No.: US 2026/0244175 A1
(43) Pub. Date: Aug. 20, 2026

(54) ELECTRONIC CONTROL DEVICE AND ELECTRONIC CONTROL METHOD

(71) Applicant: Nissan Motor Co., Ltd., Yokohama-shi, Kanagawa (JP)

(72) Inventors: Takashi MATSUMOTO, Kanagawa (JP); Kosuke TOMITA, Kanagawa (JP)

(21) Appl. No.: 18/993,307

(22) PCT Filed: Jul. 7, 2023
(86) PCT No.: PCT/JP2023/025293

§ 371 Date: Jan. 10, 2025

(30) Foreign Application Priority Data
Jul. 15, 2022 (JP) 2022-114225

(51) Int. Cl. G05B 15/02

(52) U.S. Cl. CPC G05B 15/02

(57) ABSTRACT

An electronic control apparatus includes first and second ECU's. The first ECU includes first and second determination circuits. A sensor detects an object when a main switch is in an off-state. The first determination circuit generates an internal trigger based on a detection value from the sensor. The first determination circuit operates at low speed when the first ECU is in a sleep state. The second determination circuit is activated in response to the internal trigger and operates at high speed to perform filtering processing. When the first and second ECU's are in the sleep state, the first determination circuit generates the internal trigger when the detection value has changed. After the second determination circuit is activated, the second determination circuit performs the filtering processing on the detection value to obtain an input value and transmits a wake-up signal to the second ECU when the input value has changed.

### TECHNICAL FIELD

The present invention relates to an electronic control apparatus and an electronic control method.

The present application claims priority based on Japanese Patent Application No. 2022-114225 filed on Jul. 15, 2022, and for designated countries where incorporation by reference to literature is permitted, the contents described in the above-described application are incorporated herein by reference and made a part of the description herein.

### BACKGROUND ART

There has been known an onboard electronic system that reduces power consumption in a standby mode (e.g., Patent Document 1). An onboard electronic system according to Patent Document 1 includes: a standby ECU that performs standby operation when an ignition is turned off; a plurality of non-standby ECUs that are slept or turned off in their normal state when the ignition is turned off; a sensor electric wire that is provided between sensors and the standby ECU and used to supply power from the standby ECU to the sensors; a sensor signal wire that is provided between the sensors and the standby ECU and carries signals from the sensors to the standby ECU; and wires G2 to G4 that are provided between the non-standby ECUs and the standby ECU and used to wake up the non-standby ECUs. In response to an input of a signal from the sensor, the standby ECU activates the non-standby ECU corresponding to the signal from the sensor, via the wires G2 to G4.

### PRIOR ART DOCUMENT

### Patent Document

Patent Document 1: JP 2010-280314 A

### SUMMARY OF INVENTION

### Problems to be Solved by Invention

However, a problem with the above-described onboard electronic system is that the standby ECU connected to the sensors needs to maintain a normal activation state, and thus the power consumed by the standby ECU increases.

A problem to be solved by the present invention is to provide an electronic control apparatus and an electronic control method that are capable of reducing the power consumption of an ECU connected to a sensor.

### Means for Solving Problems

The present invention solves the above-described problem as follows: when a first ECU and a second ECU are in a sleep state, a first determination circuit capable of operating at low speed determines whether a detection value from a sensor has changed, and generates an internal trigger when the detection value has been determined to be changed, and after a second determination circuit is activated in response to the internal trigger, the second determination circuit performs filtering processing on the detection value to obtain an input value, determines whether the input value has changed, and transmits a wake-up signal to the second ECU when the input value has been determined to be changed.

### Effects of Invention

According to the present invention, it is possible to reduce the power consumption of an ECU connected to a sensor.

### BRIEF DESCRIPTION OF DRAWINGS

FIG. 1 is a block diagram of an onboard electronic control system according to an embodiment of the present invention.

FIG. 2 is a flowchart illustrating a control processing flow performed by a first ECU when the first ECU and a second ECU are in a sleep state.

FIG. 3 is a flowchart illustrating a control processing flow performed by the first ECU when the first ECU and the second ECU are in a normal activation state.

FIG. 4 is a block diagram of a first determination circuit.

### MODE(S) FOR CARRYING OUT THE INVENTION

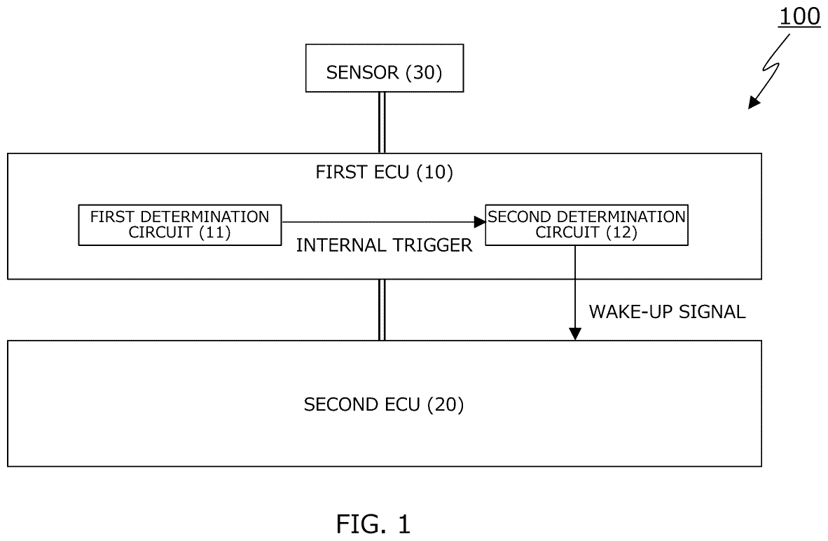

An embodiment of an electronic control apparatus and an electronic control method according to the present invention will be described below with reference to the drawings. FIG. 1 is a block diagram of an onboard electronic control system according to the embodiment of the present invention. An onboard electronic control system 100 includes a first ECU 10, a second ECU 20, and a sensor 30. The onboard electronic control system 100 is provided in a vehicle. The onboard electronic control 100 includes a communication network for transmitting control signals to pieces of onboard equipment including a battery, a motor, and a fan and includes a control unit that controls the pieces of onboard equipment. Note that an apparatus including at least the first ECU 10 and the second ECU 20 is equivalent to the “electronic control apparatus” according to the present invention, and control processing to be executed by the first ECU 10 is equivalent to the “electronic control method” according to the present invention.

The first ECU 10 and the second ECU 20 are controllers (electronic control units) that control the pieces of onboard equipment. The first ECU 10 and the second ECU 20 transmit control signals to the pieces of onboard equipment. A plurality of ECUs including the first ECU 10 and the second ECU 20 can transmit and receive signals to and from one another. The first ECU 10 and the second ECU 20 each include a memory in which a program to control a piece of onboard equipment is saved, a processor that executes the program saved in the memory, and a communication module that communicates with the piece of onboard equipment and/or another ECU. In the onboard electronic control system, a communication network that enables communication among the plurality of ECUs and/or between an ECU and a piece of an onboard equipment is built. The ECUs are connected to the communication network at its node parts. The first ECU 10 and the second ECU 20 are in the relation between a slave node and a master node, respectively. The second ECU 20 is activated by the wake-up signal transmitted from the first ECU 10.

As an example, the onboard electronic control system according to the present embodiment is applied to the following system. For example, the sensor 30 connected to the first ECU 10 is assumed to be a sensor that detects the approach of a user to the vehicle. The approach of a person serves as a trigger, causing the first ECU 10 and the second ECU 20 to shift from a sleep state to a normal activation state and control an onboard communication device so as to perform wireless communication with a key or a communication terminal owned by the user. In such a system, when the user approaches, the main switch (an ignition switch or a power switch) of the vehicle is in an off-state, and the first ECU 10 and the second ECU 20 are both in the sleep state. A part of the circuitry of the first ECU 10 is driven at low speed. Thus, the first ECU 10 determines a change in an input value from the sensor 30 to an input port of the first ECU 10 even in the sleep state. When the sensor 30 detects the approach of a person in this state, the first ECU 10 uses an internal trigger to activate a high-speed drive circuit included in the first ECU 10 based on the change in the input value to the input port. In addition, the first ECU 10 transmits a wake-up signal to the second ECU 20, causing the second ECU 20 to shift from the sleep state to the normal activation state. When the second ECU 20 enters the normal activation state, the second ECU 20 enters a state where the second ECU 20 can control the onboard communication device. This enables the onboard electronic control system to perform the wireless communication with the key or the communication terminal owned by the user. Components of the onboard electronic control system according to the present embodiment will be described below.

As illustrated in FIG. 1, the first ECU 10 is connected to the sensor 30 and includes a first determination circuit 11 that generates the internal trigger based on a detection value from the sensor 30 and a second determination circuit 12 that is activated in response to the internal trigger. The first ECU 10 is connected to the second ECU 20 via a communication line. The first determination circuit 11 is a circuit that is capable of operating at low speed when the first ECU 10 is in the sleep state. The first determination circuit 11 does not perform AD conversion that operates on a high speed clock, and does not perform filtering processing in which calculation processing is performed with a high speed clock. The first ECU 10 determines whether the detection value from the sensor 30 value has changed. When the detection value has been determined to be changed, the first ECU 10 generates the internal trigger. The detection value from the sensor 30 is input to the input port of the first ECU 10 in the form of an analog value. The first ECU 10 obtains the detection value from the sensor 30 at predetermined intervals (e.g., 50 msec) in accordance with a low speed clock and compares a previous value and a current value of the detection value from the sensor 30.

The detection value from the sensor 30 is an analog value. To determine a change in the detection value, the first ECU 10 sets a predetermined range including the previous value of the detection value and determines whether the current value of the detection value falls within the predetermined range including the previous value. The predetermined range including the previous value indicates the width of an allowance in a change from the previous value of the detection value. For example, when the previous value is assumed to be 2 V, the predetermined range is set to be the range of +1 V to +3 V. For example, the first ECU 10 may set the predetermined range such that the previous value serves as the midpoint of the predetermined range. When the current value of the detection value falls within the predetermined range, the first ECU 10 determines that the detection value has not changed. On the other hand, when the current value of the detection value is out of the predetermined range, the first ECU 10 determines that the detection value has changed. When the detection value from the sensor 30 has been determined to be changed, the first ECU 10 stores the detection value after the change in the memory as its previous value. In addition, when the detection value from the sensor 30 has been determined to be changed, the first ECU 10 generates the internal trigger. The internal trigger is an instruction to cause the second determination circuit 12 to shift from the sleep state to the normal activation state. In other words, the internal trigger is an instruction to activate a part of the circuitry of the first ECU 10.

The second determination circuit 12 is a circuit that is activated in response to the internal trigger generated by the first determination circuit 11 and operates at high speed to perform filtering processing. The second determination circuit 12 operates on a clock faster than an operation clock for the first determination circuit 11, and thus the power consumption of the second determination circuit 12 is higher than the power consumption of the first determination circuit 11. When the first ECU 10 is in the sleep state, the second determination circuit 12 is in a state of being not activated (the sleep state or a suspended state), and thus the power consumption of the first ECU 10 is reduced.

The second determination circuit 12 obtains the detection value from the sensor 30 at predetermined intervals (e.g., 10 msec) in accordance with a high speed clock, performs the filtering processing on the obtained detection value to obtain an input value, and determines whether the input value has changed. In the filtering processing, the detection value is subjected to AD conversion, and when the converted detection value maintains its continuity, the value having the continuity is taken as the input value. For example, when the same detection value is input three consecutive times, the second determination circuit 12 takes the input detection value as the input value. For example, when the detection value subjected to the AD conversion is 000 or 001, the input value is “0.” When the same detection value is input three consecutive times, such as 111, the input value is “1.” In this manner, the second determination circuit 12 executes the filtering processing in such a manner as to check the continuity of the detection value that is input in accordance with a high speed clock. Note that the filtering processing may include noise removal or the like.

The second determination circuit 12 compares a current value and a previous value of the input value, thus determining whether the input value has changed. When the current value of the input value matches the previous value of the input value, the second determination circuit 12 determines that the input value has not changed. When the input value has been determined not to be changed, the second determination circuit 12 shifts from the normal activation state to the sleep state. In addition, the second determination circuit 12 may output, to the first determination circuit 11, a state signal indicating the shift from the normal activation state to the sleep state.

When the input value has been determined to be changed, the second determination circuit 12 generates a communication event. In the communication event, the first ECU 10 transmits data to the second ECU 20. At this time, when the second ECU 20 is in the sleep state, the second determination circuit 12 transmits the wake-up signal to the second ECU 20. After the second ECU 20 shifts from the sleep state to the normal activation state, the second determination circuit 12 transmits an event occurrence instruction to the second ECU 20. The event occurrence instruction indicates that an input value to the input port of the first ECU 10 (equivalent to the detection value from the sensor 30) has changed. When the second ECU 20 is in the normal activation state, the second determination circuit 12 need not transmit the wake-up signal to the second ECU 20. When the input value has been determined to be changed, the second determination circuit 12 stores the input value after the change in the memory as its previous value.

When the wake-up signal from the first ECU 10 is received, the second ECU 20 shifts from the sleep state to the normal activation state. The second ECU 20 also controls the piece of onboard equipment in accordance with the communication event. The sensor 30 is a sensor that is capable of detecting an object irrespective of whether the main switch is in an on-state or the off-state. The sensor 30 is, for example, a camera, an infrared sensor, or a radar device. The object to be detected by the sensor may be any moving object such as a user.

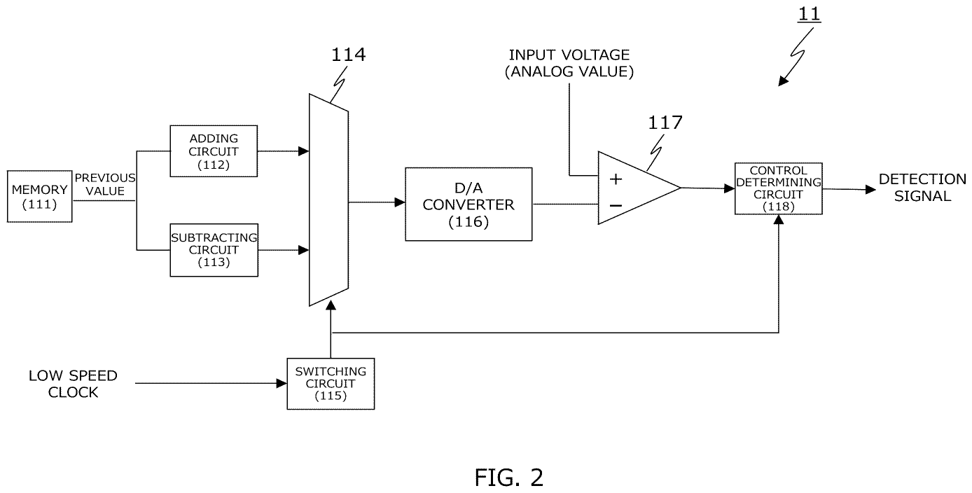

Next, with reference to FIG. 2, a circuit configuration of the first determination circuit 11 will be described. As illustrated in FIG. 2, the first determination circuit 11 includes a memory 111, an adding circuit 112, a subtracting circuit 113, a selecting circuit 114, a switching circuit 115, a D/A converter 116, a comparator 117, and a control determining circuit 118.

When it is determined that the detection value has changed, the memory 111 stores the detection value after the change as its previous value. The adding circuit 112 adds a predetermined value to the previous value to set an upper limit value of the predetermined range indicating the allowance. The subtracting circuit 113 subtracts a predetermined value from the previous value to set a lower limit value of the predetermined range indicating the allowance. The adding circuit 112 and the subtracting circuit 113 form a circuit that calculates the predetermined range including the previous value of the detection value. The adding circuit 112 and the subtracting circuit 113 are equivalent to a “calculation circuit” according to the present invention. The selecting circuit 114 selects from between a calculation value from the adding circuit 112 and a calculation value from the subtracting circuit 113 in accordance with an output of the switching circuit 115 and outputs the selected calculation value to the D/A converter 116.

The switching circuit 115 switches selection methods by the selecting circuit 114 and switches determination methods by the control determining circuit 118, in accordance with a low speed clock. For example, the switching circuit 115 outputs a switching signal to the selecting circuit 114 in such a manner that the selecting circuit 114 selects the calculation value from the adding circuit 112 in accordance with a high level of the low speed clock and selects the calculation value from the subtracting circuit 113 in accordance with a low level of the low speed clock.

The D/A converter 116 converts the output value (a digital value) from the selecting circuit 114 into an analog value and outputs the analog value to the comparator 117. Note that the D/A converter 116 is a circuit that uniquely determines an output value in accordance with a value input from the selecting circuit 114, and thus the D/A converter 116 dispenses with a clock. The comparator 117 compares an input voltage (the analog value) input from the sensor 30 to the input port of the first ECU 10 with the value input from the D/A converter 116 and outputs a result of the comparison to the control determining circuit 118. Note that the comparator 117 is supplied with an intermittent voltage from an onboard battery, and the intermittent voltage is also supplied to the sensor 30. The control determining circuit 118 determines whether the detection value from the sensor 30 has changed, from a result of the comparison of the value that is based on the calculation value from the adding circuit 112 and is input from the D/A converter 116 to the comparator 117 with the voltage input from the sensor 30 to the comparator 117, and from a result of the comparison of the value that is based on the calculation value from the subtracting circuit 113 and is input from the D/A converter 116 to the comparator 117 with the voltage input from the sensor 30 to the comparator 117. The control determining circuit 118 then outputs a signal corresponding to a result of the determination as a detection signal.

In this manner, the first determination circuit 11 uses the low speed clock to perform intermittent monitoring on the input to the input port of the first ECU 10. In the intermittent monitoring, calculation processing for the AD conversion and the filtering processing are not performed. Thus, the power consumption is reduced. When the input to the input port has changed, the first determination circuit 11 activates the second determination circuit 12, which is a circuit performing the calculation processing for the AD conversion and the filtering processing in the first ECU 10 being the slave node. From a result of the filtering processing, the first determination circuit 11 determines whether the input (analog value) to the input port has changed. When the input has changed, the first determination circuit 11 transmits the wake-up signal to the second ECU 20. On the other hand, when the input has not changed, the first ECU 10 does not transmit the wake-up signal but returns the second determination circuit 12 to the sleep state, and continues the intermittent monitoring with the first determination circuit 11.

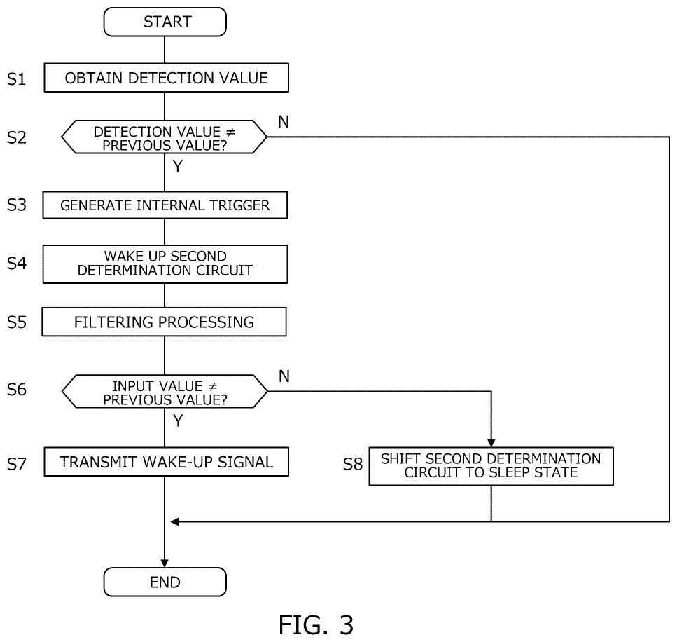

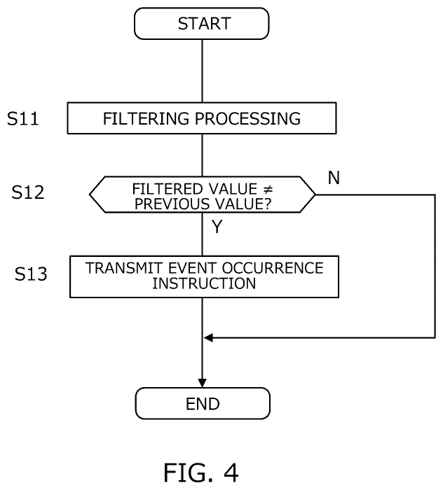

Next, with reference to FIG. 3 and FIG. 4, a control processing flow of the first ECU 10 will be described. FIG. 3 illustrates a control flow of a case where the first ECU 10 and the second ECU 20 are in the sleep state, and FIG. 4 illustrates a control flow of a case where the first ECU 10 and the second ECU 20 are in the normal activation state.

As illustrated in FIG. 3, in step S1, the first ECU 10 obtains the detection value from the sensor 30, which is input to the input port. In step S2, the first ECU 10 uses the first determination circuit 11 to compare the current value and the previous value of the detection value, thus determining whether the detection value has changed. When the detection value has been determined not to be changed, the first ECU 10 finishes the control processing. Note that the first ECU 10 and the second ECU 20 remain in the sleep state.

On the other hand, when the detection value has been determined to be changed, the first ECU 10 generates, in step S3, the internal trigger to activate the second determination circuit 12. The first ECU 10 also stores the detection value after the change in the memory as its previous value. In step S4, the second determination circuit 12 is activated (wakes up). In step S5, the first ECU 10 uses the second determination circuit 12 to perform the filtering processing on the detection value from the sensor 30, thus obtaining the input value. The first ECU 10 uses the second determination circuit 12 to compare the current value and the previous value of the input value, thus determining whether the input value has changed. When the input value has been determined to be changed, the first ECU 10 transmits, to the second ECU 20, the wake-up signal to activate the second ECU 20 (step S7). The first ECU 10 also stores the input value after the change in the memory as its previous value. The first ECU 10 then finishes the control processing.

When the input value has been determined not to be changed, the first ECU 10 causes, in step S8, the second determination circuit 12 to shift to the sleep state and finishes the control processing.

When the main switch is in the on-state, and the first ECU 10 and the second ECU 20 are in the normal activation state, the first ECU 10 executes the control processing flow illustrated in FIG. 4. Since the second determination circuit 12 is in the normal activation state, the filtering processing is functioning effectively. In step S11, the first ECU 10 uses the second determination circuit 12 to perform the filtering processing on the detection value from the sensor 30, thus obtaining the input value.

In step S12, the first ECU 10 uses the second determination circuit 12 to compare the current value and the previous value of the input value, thus determining whether the input value has changed. When the input value has been determined to be changed, the first ECU 10 transmits the event occurrence instruction to the second ECU 20 (step S13). The first ECU 10 also stores the input value after the change in the memory as its previous value. The first ECU 10 then finishes the control processing. When the input value has been determined not to be changed, the first ECU 10 finishes the control processing.

As described above, the electronic control apparatus according to the present embodiment includes the first ECU 10 connected to the sensor 30 capable of detecting an object when the main switch is in the off-state, and includes the second ECU 20 connected to the first ECU 10 via the communication line. The first ECU 10 includes the first determination circuit 11 that generates the internal trigger based on the detection value from the sensor 30 and the second determination circuit 12 that is activated in response to the internal trigger. The first determination circuit 11 is a circuit that is capable of operating at low speed when the first ECU 10 is in the sleep state, and the second determination circuit 12 is a circuit that is activated in response to the internal trigger generated by the first determination circuit 11 and operates at high speed to perform the filtering processing. When the first ECU 10 and the second ECU 20 are in the sleep state, the first determination circuit 11 determines whether the detection value has changed, and, when the detection value has been determined to be changed, generates the internal trigger. After the second determination circuit 12 is activated in response to the internal trigger, the second determination circuit 12 performs the filtering processing on the detection value from the sensor 30 to obtain the input value, determines whether the input value has changed, and, when the input value has been determined to be changed, transmits the wake-up signal to the second ECU. This enables the first ECU 10 to determine, with low power consumption, whether the detection value has changed and to activate, with low power consumption, the second ECU 20 when the detection value has changed. As a result, the power consumption of the first ECU 10 connected to the sensor 30 can be reduced.

The electronic control method according to the present embodiment is executed by the processor included in the first ECU 10. The processor determines whether the detection value from the sensor 30 has changed with the first determination circuit 11 when the first ECU 10 and the second ECU 20 are in the sleep state, and generates the internal trigger when the detection value has been determined to be changed. The processor performs the filtering processing on the detection value from the sensor 30 to obtain the input value with the second determination circuit 12 after activating the second determination circuit 12 with the internal trigger, determines whether the input value has changed, and transmits the wake-up signal to the second ECU 20 when the input value has been determined to be changed. This enables the first ECU 10 to determine, with low power consumption, whether the detection value has changed and to activate, with low power consumption, the second ECU 20 when the detection value has changed. As a result, the power consumption of the first ECU 10 connected to the sensor 30 can be reduced.

In the electronic control apparatus according to the present embodiment, when the second determination circuit 12 determines that the input value has changed, the second determination circuit 12 stores the input value after the change as its previous value and compares an input value (the current value) with the previous value to determine whether the input value has changed. This enables the second determination circuit 12 to detect the change in the detection value from the sensor 30 in two stages and enables the determination circuit to be activated according to each stage. As a result, a dark current can be reduced in two stages.

In the electronic control apparatus according to the present embodiment, when the first ECU 10 and the second ECU 20 are in the normal activation state, the second determination circuit 12 determines whether the input value obtained by performing the filtering processing on the detection value from the sensor 30 has changed, and the second determination circuit 12 transmits the event occurrence instruction to the second ECU 20 when the input value has been determined to be changed. That is, the first ECU 10 need not regularly transmit the presence or absence of the occurrence of the event. It suffices that the first ECU 10 transmits the event occurrence instruction when the input value has changed. This enables the reduction in the power consumption of the first ECU 10.

In the electronic control apparatus according to the present embodiment, the first determination circuit 11 determines, at the predetermined intervals, whether the detection value from the sensor 30 has changed. This enables the determination of whether the detection value has changed to be performed with the low speed clock, and thus the power consumption of the first ECU 10 can be reduced.

In the electronic control apparatus according to the present embodiment, when the first determination circuit 11 determines that the detection value has changed, the first determination circuit 11 stores the detection value after the change as its previous value and determines, in accordance with whether the current value of the detection value falls within predetermined range including the previous value, whether the detection value has changed. This enables the determination of whether the detection value has changed to be performed even when the input to the input port is an analog value.

In the electronic control apparatus according to the present embodiment, the second determination circuit 12 shifts to the sleep state when the input value obtained by performing the filtering processing on the detection value from the sensor 30 has been determined not to be changed. This enables the reduction in the power consumption of the second ECU 20.

In the electronic control apparatus according to the present embodiment, the first determination circuit 11 includes the memory 111 in which, when it is determined that the detection value has changed, the detection value after the change is stored as its previous value, the calculation circuit that calculates the predetermined range including the previous value, and the comparator 117 that compares the detection value with the calculation value from the calculation circuit. This enables the determination of whether the detection value has changed to be performed even when the input to the input port is an analog value.

The embodiment explained above is described to facilitate the understanding of the present invention and is not described to limit the present invention. It is therefore meant that the constituent elements disclosed in the above embodiment include all design changes and equivalents falling within the technical scope of the present invention.

### DESCRIPTION OF REFERENCE NUMERALS

10 first ECU
11 first determination circuit
12 second determination circuit
20 second ECU
30 sensor
100 onboard electronic control system
111 memory
112 adding circuit
113 subtracting circuit
114 selecting circuit
115 switching circuit
116 D/A converter
117 comparator
118 control determining circuit

1. An electronic control apparatus comprising:
a first ECU that is connected to a sensor and includes a first determination circuit and a second determination circuit, the sensor being capable of detecting an object when a main switch is in an off-state, the first determination circuit generating an internal trigger based on a detection value from the sensor, the second determination circuit being activated in response to the internal trigger; and
a second ECU that is connected to the first ECU via a communication line, wherein
the first determination circuit is a circuit capable of operating at low speed when the first ECU is in a sleep state,
the second determination circuit is a circuit that is activated in response to the internal trigger generated by the first determination circuit and operates at high speed to perform filtering processing, and
when the first ECU and the second ECU are in the sleep state,
the first determination circuit determines whether the detection value has changed and generates the internal trigger when the detection value has been determined to be changed, and
after the second determination circuit is activated in response to the internal trigger, the second determination circuit performs the filtering processing on the detection value to obtain an input value, determines whether the input value has changed, and transmits a wake-up signal to the second ECU when the input value has been determined to be changed.

2. The electronic control apparatus according to claim 1, wherein
the second determination circuit:
stores the input value after change as a previous value when the input value has been determined to be changed; and
compares the input value with the previous value to determine whether the input value has changed.

3. The electronic control apparatus according to claim 1, wherein
when the first ECU and the second ECU are in a normal activation state, the second determination circuit determines whether an input value has changed, and the second determination circuit transmits an event occurrence instruction to the second ECU when the input value has been determined to be changed, the input value being obtained by performing the filtering processing on the detection value.

4. The electronic control apparatus according to claim 1, wherein
the first determination circuit determines, at a predetermined interval, whether the detection value has changed.

5. The electronic control apparatus according to claim 1, wherein
the first determination circuit stores the detection value after change as a previous value when the detection value has been determined to be changed, and
the first determination circuit determines whether the detection value has changed in accordance with whether a current value of the detection value falls within a predetermined range including the previous value.

6. The electronic control apparatus according to claim 5, wherein
the previous value is a midpoint of the predetermined range.

7. The electronic control apparatus according to claim 5, wherein
the first determination circuit determines that the detection value has changed when the current value of the detection value is out of the predetermined range.

8. The electronic control apparatus according to claim 1, wherein
the second determination circuit shifts to the sleep state when the input value has been determined not to be changed.

9. The electronic control apparatus according to claim 1, wherein
the first determination circuit includes:
a memory in which the detection value after change is stored as a previous value when the detection value has been determined to be changed;
a calculation circuit that calculates a predetermined range including the previous value; and
a comparator that compares the detection value with a calculation value from the calculation circuit.

10. An electronic control method comprising:
the first ECU:
determining whether a detection value from a sensor has changed with a first determination circuit when a first ECU and a second ECU are in a sleep state and generating an internal trigger when the detection value has been determined to be changed,
the sensor being capable of detecting an object when a main switch is in an off-state, the first ECU connected to the sensor, connected to the second ECU via a communication line; and including the first determination circuit and the second determination circuit,
the first determination circuit is configured to generate an internal trigger based on the detection value from the sensor, be capable of operating at low speed when the first ECU is in the sleep state,
the second determination circuit is configured to be activated in response to the internal trigger generated by the first determination circuit and operate at high speed to perform filtering processing;
performing the filtering processing on the detection value to obtain an input value with the second determination circuit after activating the second determination circuit with the internal trigger; and
determining whether the input value has changed, and transmitting a wake-up signal to the second ECU when the input value has been determined to be changed.
